(19) United States
(12) Patent Application Publication
(10) Pub. No.: US 2025/0380070 A1
(43) Pub. Date: Dec. 11, 2025

(54) ACOUSTIC HORN FOR SPEAKER WITH CURVED SURFACES

(71) Applicant: SAGEMCOM BROADBAND SAS, BOIS-COLOMBES (FR)

(72) Inventors: Jérémy STANGALINI, BOIS-COLOMBES (FR); Gilles BOURGOIN, BOIS-COLOMBES (FR); Charles-Efflam MARTIN DE MONTAUDRY, BOIS-COLOMBES (FR)

(21) Appl. No.: 19/234,676

(22) Filed: Jun. 11, 2025

(30) Foreign Application Priority Data
Jun. 11, 2024 (FR) FR2406198

(51) Int. Cl. H04R 1/02

(52) U.S. Cl. CPC H04R 1/02

(57) ABSTRACT

An acoustic horn, arranged to be integrated into a sound box by forming a recess in a face of the sound box, includes a bottom, in which at least two elliptical holes are formed, in each of which a diaphragm of a loudspeaker integrated into the sound box can extend; and an edge including an upper surface defining a contour of the edge and intended to extend on the face of the sound box, and an inner side wall which connects the bottom of the acoustic horn to the upper surface of the edge, the edge partially running along each elliptical hole such that its contour has curved portions matching the shape of the elliptical holes.

### BACKGROUND

It is considered to design an acoustic speaker having curved external surfaces, and in particular a speaker with a “capsule” shape. This speaker can optionally comprise a support enabling to position it vertically on a flat surface (of a piece of furniture, for example). The speaker can also be placed directly in a horizontal position on this flat surface.

The speaker is, for example, a “satellite” speaker intended to be connected to a device configured to broadcast sound content, such as a set-top box (STB). The set-top box itself possibly integrates one or more loudspeakers.

Such a speaker typically comprises a sound box. This is a waterproof casing in which one or more loudspeakers are integrated. The casing can be constituted of a single part or can be obtained by the assembly of a plurality of parts.

The sound box, which also has a shape close to that of a capsule, defines a technical volume necessary for the implementation of the technical functions of the audio part of the speaker. The box delimits the acoustic volume, and integrates the loudspeakers and the connections for bringing the audio signals to the loudspeakers. This technical volume can also be used to integrate components implementing “transversal” functions: control, communication (Wi-Fi interface, for example), electrical power supply, etc.

The acoustic speaker also comprises one or more protective parts mounted on the box and which cover (at least) the loudspeaker diaphragms to protect them from external aggressions. These protective parts comprise holes to let out the sounds generated by the loudspeakers. These protective parts also enable to give the speaker a certain aesthetic appearance. A fabric sometimes covers the protective parts in full or in part, which then also fulfil the support function of said fabric.

Generally, in a conventional acoustic speaker, the loudspeakers are mounted directly on a flat front of the speaker. However, here, the speaker and the box have curved external surfaces and therefore, their faces are not flat.

It is therefore, considered to move the loudspeakers back relative to the external surface of the box. This setback depends on the shape of the box (and of the speaker), and can be relatively large, which implies, for each loudspeaker, to provide a guiding device enabling to guide the sounds produced by the loudspeaker outwards.

Speakers are known in which the loudspeakers are moved back relative to the external surface of the speaker, and which are equipped, for each loudspeaker, with a “guide pipe” of general shape close to that of a cylindrical shape.

This solution has the following disadvantages.

When the depth of the loudspeakers is large (for example, a few tens of millimetres), the cylindrical shape of the guide pipe does not enable to ensure a good quality of sound rendering because of the acoustic resonances taking place inside the guide pipe in the direction of depth. In addition, the homogeneity of the diffusion of sound is unsatisfactory, in particular at high frequencies.

Furthermore, the assembly of the different guide pipes is relatively complex, in particular if the box comprises several loudspeakers whose diaphragms are positioned on the same face of the box. It is then very difficult to ensure a certain level of compactness and rigidity of the speaker.

### OBJECT

The object of the invention is to improve the acoustic rendering, the compactness and the rigidity of an acoustic speaker having curved external surfaces and comprising several loudspeakers on the same face.

### SUMMARY

In order to achieve this aim, an acoustic horn is proposed, arranged to be integrated into an sound box by forming a recess in a face of said sound box, the acoustic horn comprising:
a bottom, in which at least two elliptical holes are formed, in each of which a diaphragm of a loudspeaker integrated into said sound box can extend;
an edge comprising an upper surface defining a contour of the edge and intended to extend on said face of said sound box, and an inner side wall which connects the bottom of the acoustic horn to the upper surface of the edge, the edge partially running along each elliptical hole such that its contour has curved portions matching the shape of said elliptical holes.

The elliptical holes in the bottom of the acoustic horn enable to integrate the loudspeakers into the box such that they are positioned close to the upper surface of the edge of the horn and therefore, to the face of the box, even if it has curved surfaces.

The shape of the contour of the edge of the horn and the use of the same horn for at least two loudspeakers enable to reduce resonance phenomena and to obtain a more homogeneous diffusion of the sound. The acoustic rendering is improved considerably.

The use of a same horn for at least two loudspeakers enables to improve the rigidity of the speaker. The loudspeakers can be brought closer together, which improves the compactness of the speaker.

In addition, an acoustic horn as previously described is proposed, in which the bottom comprises a first elliptical hole and a second elliptical hole with a diameter less than that of the first elliptical hole, the contour of the edge having the general shape of a trapezoid having rounded bases and angles.

In addition, an acoustic horn as previously described is provided, in which, when the acoustic horn is viewed in cross-section along a plane perpendicular to a flat surface of the bottom, the inner side wall of the edge has a convex shape, at least on one curved portion of the edge which runs along the second elliptical hole.

In addition, an acoustic horn such as previously described is proposed, in which a maximum distance between each elliptical hole and the inner side wall of the edge is less than or equal to half a wavelength corresponding to a maximum frequency rendered by the loudspeaker having a diaphragm that can extend into the second elliptical hole.

In addition, an acoustic horn such as previously described is proposed, in which a maximum depth of the acoustic horn is less than or equal to half a wavelength corresponding to a maximum frequency rendered by the loudspeaker having a diaphragm that can extend into the second elliptical hole.

In addition, a one-piece part is proposed, forming a portion of a sound box, the one-piece part comprising a face of said sound box and integrating an acoustic horn as previously described, the acoustic horn forming a recess in said face.

In addition, a sound box is proposed, comprising an acoustic horn as previously described or a one-piece part as previously described.

In addition, an acoustic speaker is proposed, comprising a sound box as previously described and at least two loudspeakers integrated into the sound box, a diaphragm of each loudspeaker extending into one of the elliptical holes of the acoustic horn.

In addition, an acoustic speaker as previously described is provided, the bottom of the acoustic horn comprising a first elliptical hole and a second elliptical hole with a diameter less than that of the first elliptical hole, the acoustic speaker comprising a first loudspeaker having a diaphragm that extends into the first elliptical hole and a second loudspeaker having a diaphragm that extends into the second elliptical hole.

In addition, an acoustic speaker as previously described is proposed, a maximum distance between each elliptical hole and the inner side wall of the edge of the acoustic horn being less than or equal to half a wavelength corresponding to a maximum frequency rendered by the second loudspeaker.

In addition, an acoustic speaker as previously described is proposed, a maximum depth of the acoustic horn being less than or equal to half a wavelength corresponding to a maximum frequency rendered by the second loudspeaker.

In addition, an acoustic speaker as previously described is proposed, the first loudspeaker being recessed deeper into the box than the second loudspeaker.

The invention will be better understood in light of the following description of a particular and non-limiting embodiments of the invention.

### BRIEF DESCRIPTION OF THE DRAWINGS

FIG. 1 is a perspective view of a speaker integrating a horn according to a first embodiment;

FIG. 2 is an exploded view of a speaker integrating a horn according to a second embodiment;

FIG. 3 shows two perspective views, one from the front and the other from three-quarters of the sound box of the speaker of FIG. 1;

FIG. 4 is a detailed view of the first view of FIG. 3 (without the loudspeaker diaphragms);

FIG. 5 shows a graph comprising curves of the horizontal directivity at 16 kHz of a a speaker of the prior art with two guide pipes, and a speaker with a horn according to FIG. 1, as well as a similar graph for the vertical directivity;

FIG. 6 shows four horns having different profiles;

FIG. 7 shows a simplified modelling of a speaker with a horn having a concave profile, and a similar modelling of a speaker with a horn having a convex profile;

FIG. 8 shows a graph comprising a curve of the frequency response to one metre of a speaker with a horn having a concave profile, and a similar curve for a 5 speaker with a horn having a convex profile;

FIG. 9 shows a graph on which the acoustic field is visible at 13.6 kHz generated by a speaker with a horn having a concave profile, and a similar graph for a speaker with a horn having a convex profile;

FIG. 10 is a Figure similar to FIG. 3, for the speaker integrating the horn according to the second embodiment.

FIG. 11 shows side views of the speaker and its support, before and after mounting the support on the speaker, according to a “table stand” mounting configuration;

FIG. 12 is a Figure similar to FIG. 11, according to a “wall mount” configuration;

FIG. 13 shows a front view of the support in the “table stand” configuration, and a front view of the support in the “wall mount” configuration;

FIG. 14 shows views of the support according to a particular embodiment, before and after folding the curved portion;

FIG. 15 shows a plurality of views illustrating the support according to a particular embodiment, in which the curved portion is headed on the base.

### DETAILED DESCRIPTION

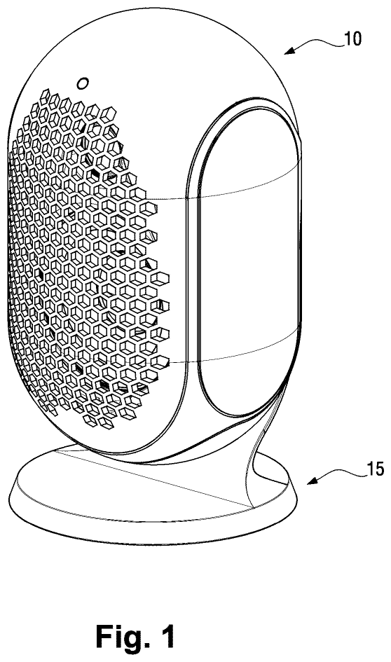

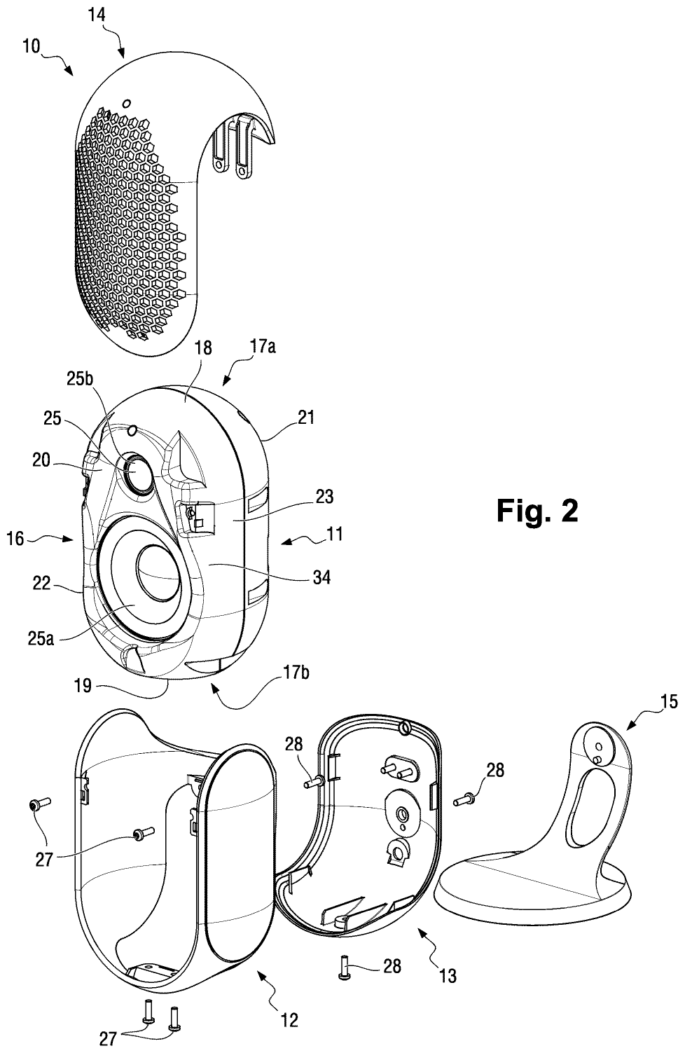

With reference to FIGS. 1 and 2, the acoustic speaker 10 is here a portable speaker which comprises curved external surfaces and more precisely has the shape of a “capsule”.

The acoustic speaker 10 comprises:
a sound box according to a first embodiment 11;
a first shell 12;
a second shell 13;
a protective part 14;
a support 15.

In the nominal operating position, the speaker 10 is positioned vertically. All the positioning terms used here must be interpreted considering that the speaker 10 is in this nominal operating position.

The sound box 11 comprises a central portion 16 and two ends 17a, 17b, hemispherically-shaped.

The end 17a forms a upper face 18 of the box 11. The end 17b forms a lower face 19 of the box 11. The central part 16 comprises side faces comprising a front face 20, a rear face 21, a left face 22 and a right face 23 of the box 11.

The sound box 11 also has the general shape of a capsule, but which is flattened at its front face 20 and its rear face 21. All the external surfaces of the box 11 are curved surfaces.

Here, two loudspeakers 25 are integrated in the sound box 11 (the loudspeaker diaphragms can be seen in FIG. 2). The first loudspeaker 25a is a Woofer type loudspeaker. This is a loudspeaker that reproduces low frequencies, for example, of between 100 Hz and 2 kHz. The term woofer is also used to designate this type of loudspeaker.

The second loudspeaker 25b is a Tweeter type loudspeaker. This is a loudspeaker that reproduces high frequencies, for example, of between 2 kHz and 20 kHz. The term treble loudspeaker is also used to designate this type of loudspeaker. The diameter of the diaphragm of the second loudspeaker 25b is less than that of the diaphragm of the first loudspeaker 25a.

The first loudspeaker 25a is integrated in the sound box 11 such that its diaphragm is positioned at a lower portion of the front face 20 of the sound box 11. The second loudspeaker 25b is integrated in the sound box 11 such that its diaphragm is positioned at an upper portion of the front face 20 of the sound box 11.

The first shell 12 aims to protect the left face 22 and the right face 23 of the box 11. The first shell 12 is fixed to the box by screws 27.

The second shell 13 aims to protect the rear face 21 and the lower face 19 of the box 11. The second shell 13 is fixed to the box by screws 28.

The protective part 14 aims in particular to protect the front face 20 and the upper face 18 of the box 11.

The support 15 will be described below in this description.

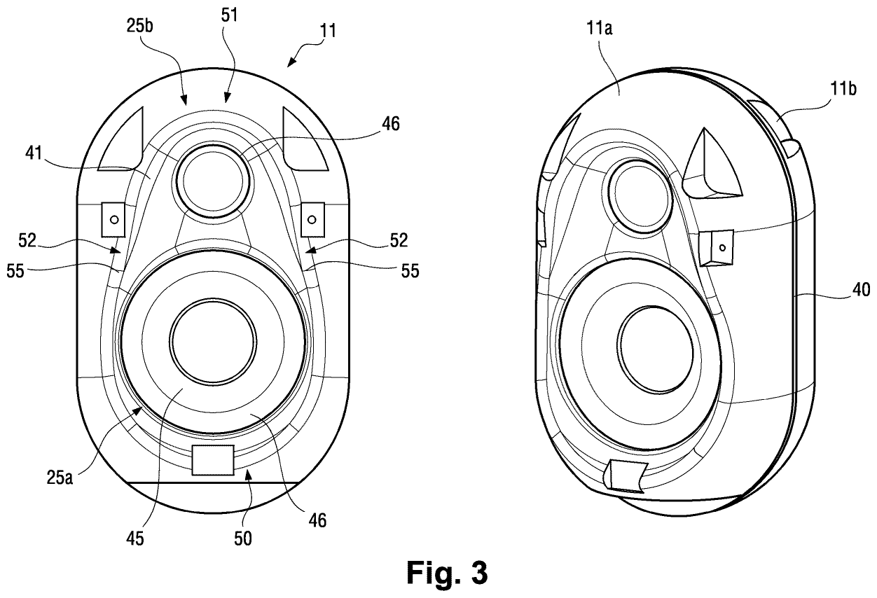

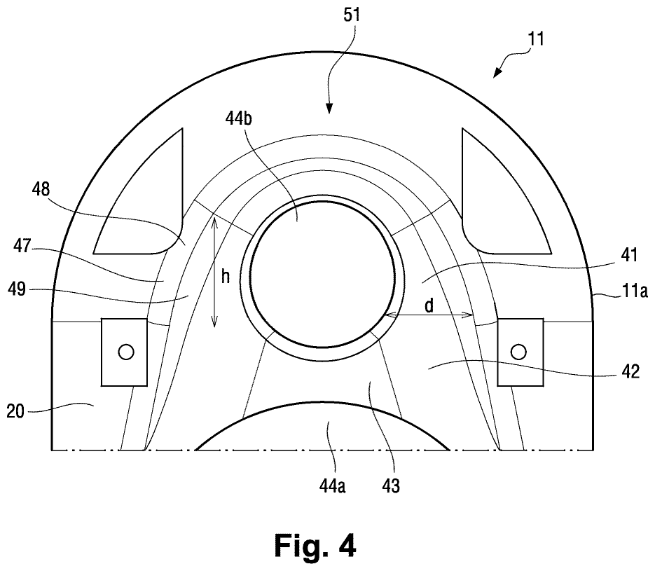

With reference to FIGS. 3 and 4, the sound box 11 here comprises two half-shells 11a, 11b and a seal 40 which extends on the edges of the half-shells 11a, 11b. When the sound box 11 is assembled, the seal 40 is compressed and ensures acoustic sealing of the box 11.

The sound box 11 comprises an acoustic horn 41. The acoustic horn 41 is integrated in the sound box 11 by forming a recess in one face of said sound box 11. The face in question is here the front face 20.

Here, the sound box 11 comprises a one-piece part, forming a portion of the box 11. The one-piece part comprises one face of said sound box 11, in this case, the front face 20, and integrates the horn 41. The horn 41 therefore, forms a cavity consisting of a hollow one-piece part. This one-piece part is the front half-shell 11a.

The horn 41 comprises a bottom 42, comprising a flattened section forming a flat surface 43, and at least two elliptical holes 44a, 44b formed in the bottom 42 of the horn, and in each of which a diaphragm 45 of a loudspeaker 25 integrated in the sound box 11 can extend.

The flat surface 43 extends between the two holes 44a, 44b in a plane perpendicular to the depth of the horn 41.

Here, the bottom 42 comprises two elliptical holes 44a, 44b which are circular holes. Consideration is thus given that a circle is a special case of an ellipse.

The diaphragm 45 of the first loudspeaker 25a extends into the first hole 44a. The diaphragm 45 of the first loudspeaker 25a is fixed to a contour of the first hole 44a via a toroidal-shaped suspension 46.

The diaphragm 45 of the second loudspeaker 25b extends into the second hole 44b. The diaphragm 45 of the second loudspeaker 25b is fixed to a contour of the second hole 44b via a toroidal-shaped suspension 46.

The horn 41 also comprises an edge 47. The edge 47 comprises an upper surface 48 that defines a contour of the edge 47 and that extends over the front face 20 of the box 11, and an inner side wall 49 that connects the bottom 42 to the upper surface 48 of the edge 47. The upper surface 48 of the edge 47 forms a bead on the front face 20 of the box 11.

The edge 47 partially runs along each hole 44a, 44b such that its contour has bends that match the shape of said holes 44a, 44b.

The contour of the edge 47, i.e. the edge 47 itself when the horn 41 is viewed from the front, according to a front view, as is the case in the left view of FIG. 3, has a first curved portion 50, which runs along the lower part of the first hole 44a, and a second curved portion 51, which runs along the upper part of the second hole 44b. The bend radius of the first curved portion 50 is close to the radius of the first hole 44a. The bend radius of the second curved portion 51 is close to the radius of the second hole 44b.

The contour also comprises two connecting portions 52 which connect the first curved portion 50 and the second curved portion 51, and which are themselves here curved towards the inside of the horn 41.

The diameter of the second hole 44b is less than that of the first hole 44a, such that the contour of the edge 47 has the general shape of a trapezoid having rounded bases and angles.

As illustrated in FIG. 3, the sides of the trapezoid defining the contour of the edge 47 can be curved and preferably have a flexing point 55 at a central zone of the horn, here in a zone of between the two loudspeakers 25a, 25b. Thus, the contour of the edge 47 is configured so as to closely match the diaphragm of the loudspeakers, which has the advantage or effect of avoiding undesirable resonance phenomena.

The horn 41 is therefore, shaped according to a volume similar to that of a half avocado, except that the bottom 42 comprises a flat surface 43.

Advantageously, the inner side wall 49 of the edge 47 is positioned very close to the first hole 44a and the second hole 44b, in particular, at the first curved portion 50 and the second curved portion 51 of the contour of the edge 47.

Here, a maximum distance between each elliptical hole 44a, 44b and the inner side wall 49 of the edge 47 is less than or equal to half a wavelength corresponding to a maximum frequency rendered by the second loudspeaker 25b.

By “maximum rendered frequency”, this means, in this case, the maximum frequency that the loudspeaker is capable of rendering or the maximum frequency for which the loudspeaker is used. The maximum rendered frequency is a data defined by the manufacturer of the loudspeaker in the data sheet of the loudspeaker.

By bringing the inner side wall 49 closer to the edge 47 of the horn 41 of the loudspeakers 25, undesirable resonance phenomena are avoided, in particular at the tweeter (second loudspeaker 25b).

Advantageously, the maximum depth h of the horn 41, defined as being the maximum distance between the bottom 42 of the acoustic horn 41 and the upper surface 48 of the edge 47, is also less than or equal to half the wavelength corresponding to the maximum frequency rendered by the second loudspeaker 25b.

This further limits the phenomena of undesirable resonances. Analogies can be made with the Kundt tube, closed at one end (which in this case, corresponds to the flat surface of the bottom of the horn) and open at the other (which in this case, corresponds to the open air). Resonance modes take place in the tube according to the following formula:

$$f = n * C / 2 L ,$$

where n is a natural integer, C is the speed of sound in the air and L is the length of the tube (in this case, the depth of the cavity of the horn 41). If the depth of the horn 41 complies with these conditions, the frequencies of the tweeter 25b remain lower than these resonance modes.

According to an example of a particular implementation, the maximum frequency rendered by the tweeter 25b is equal to 20 kHz, which corresponds in air to a wavelength of 17 mm, i.e. a maximum distance d and depth h of 8.5 mm.

As has been seen, the part 11a integrating both the front face 20 of the box 11 and the horn 41 is a one-piece part, unlike the speakers of the prior art, in which the guide pipes associated with the different loudspeakers are separate parts of the front shell, so much so that the guide pipes need to be assembled to the front shell.

Thus, the horn 41 is directly integrated to the front face 20 of the box 11, which has the main advantages of optimising manufacturing costs, of reducing the number of parts of the speaker 10 and of facilitating the assembly of the speaker 10.

Furthermore, the trapezoidal shape contour with rounded bases and corners (in the shape of an “avocado”) enables to optimise the directivity of the speaker 10, i.e. its ability to diffuse the sound as uniformly as possible in the space.

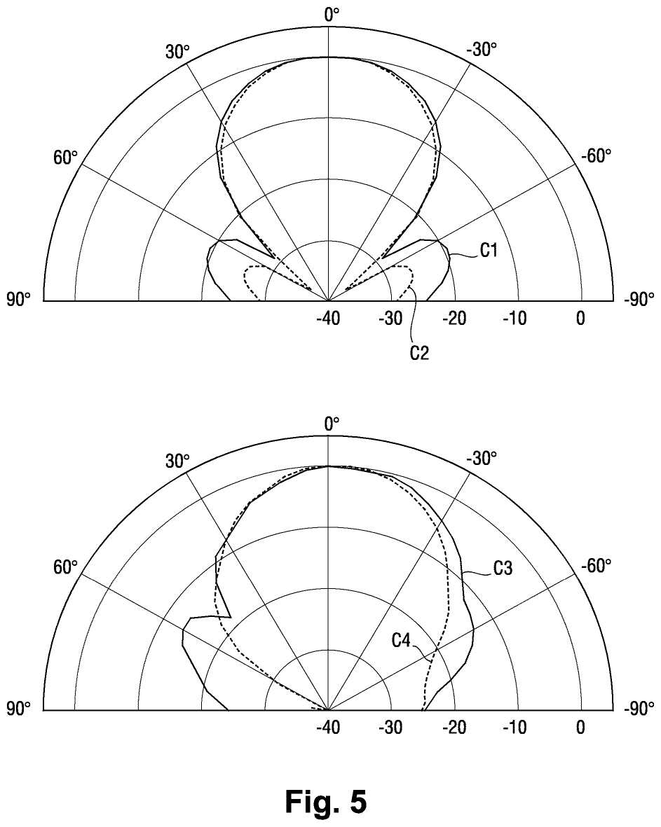

The speaker 10 provided with the horn 41 therefore, supplies a more homogeneous diffusion of sound, particularly, at high frequencies (for example, at 16 kHz). In the graph at the top of FIG. 5 (horizontal normalised directivity of the second loudspeaker 25b at 16 kHz), it can be seen that the sound level of curve C1, which corresponds to the speaker 10 with the horn 41, is higher than that of curve C2, which corresponds to a speaker with two conventional guide pipes. The sound level is, for exa10 dB higher than 60° for the speaker with the horn 41.

Similarly, on the graph at the bottom (normalised vertical directivity of the second loudspeaker 25b at 16 kHz), it can be seen that the sound level of the curve C3, which corresponds to the speaker 10 with the horn 41, is higher than that of the curve C4, which corresponds to a speaker with two conventional guide pipes.

The graphs in FIG. 5 therefore, confirm the improvement in the homogeneity of the sound diffusion, which is clearly visible from a measurement angle of 60°.

To further improve the acoustic rendering of the speaker, the surface of the horn is shaped so as to have convex edges, in particular around the second loudspeaker 25b rendering the high frequencies, i.e. in the upper end of the box 41.

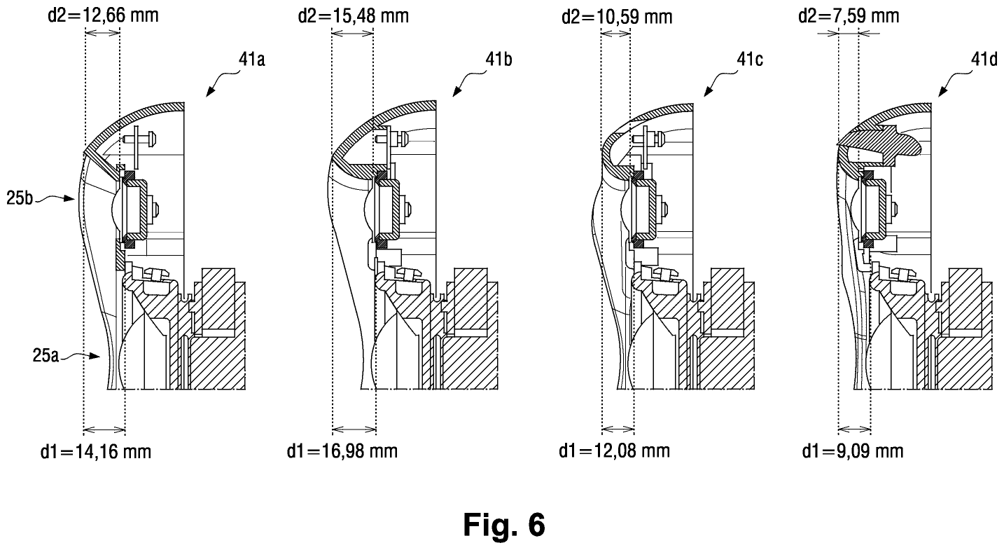

FIG. 6 shows different profiles of the horn. The inner side wall 47 of the edge 49 of the horn 41a is not convex. The inner side wall of the edge of the horn 41b is slightly convex. The inner side wall and the upper surface of the edge of the horn 41c are convex. The inner side wall and the upper surface of the edge of the horn 41d are even more convex.

It can be seen that the first loudspeaker 25a is recessed deeper into the horn than the second loudspeaker 25b. The second loudspeaker 25b is therefore, slightly brought forward, according to the depth of the horn 41, relative to the first loudspeaker 25a.

Thus, the distance d1 between the top of the suspension of the first loudspeaker 25a and the upper surface of the edge is greater than the distance d2 between the top of the suspension of the second loudspeaker 25b and the upper surface of the edge.

For the horn 41a, the distance d1 is equal to 14.16 mm. The distance d2 is equal to 12.66 mm.

For the horn 41b, the distance d1 is equal to 16.98 mm. The distance d2 is equal to 15.48 mm.

For the horn 41c, the distance d1 is equal to 12.08 mm. The distance d2 is equal to 10.59 mm.

For the horn 41d, the distance d1 is equal to 9.09 mm. The distance d2 is equal to 7.59 mm.

It can be seen that the convexity enables to compensate for the height of the wall seen by the second loudspeaker 25b, and to reduce the width of the surface of the bottom extending between each elliptical hole 44a, 44b and the inner side wall 49 of the edge 47.

Thus, advantageously, the inner side wall 49 of the edge 47 has a convex shape, at least on the second curved portion 51 of the edge 47 which runs along the second hole 44b.

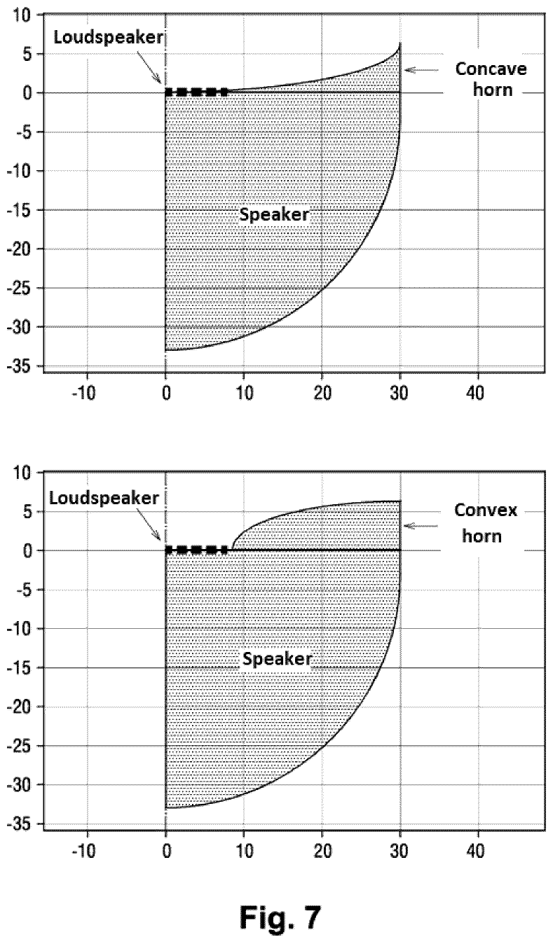

FIG. 7 shows a simplified modelling of a speaker with a concave profile horn, and a simplified modelling of a speaker with a convex profile horn.

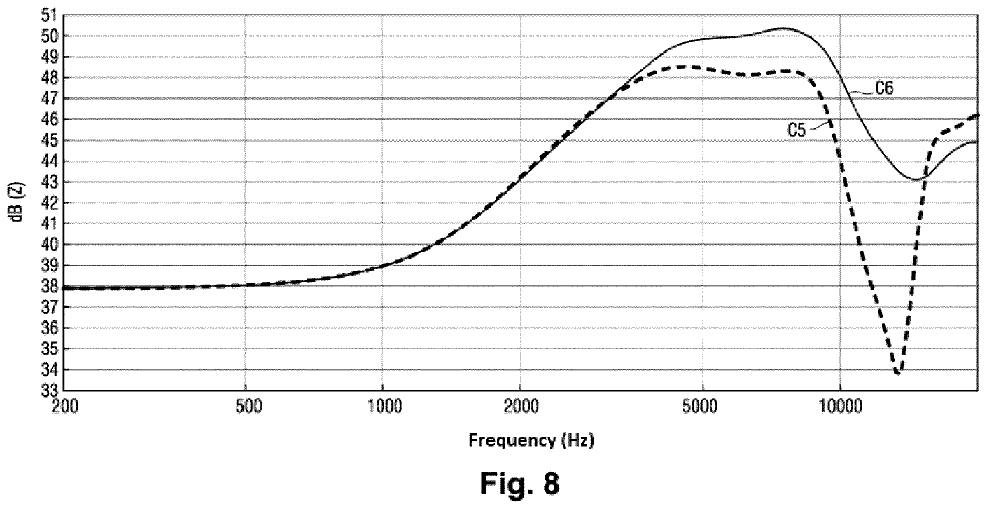

The acoustic response of these speakers was simulated. The result of these simulations can be seen in FIG. 8.

It can be seen that the curve C5 of the frequency response at 1 m from the speaker provided with a horn whose edge has a concave profile has an absorption peak at 13 kHz which is very marked, which corresponds to a resonance frequency link to the diameter of the horn whose edge has a concave profile.

It can be seen that this phenomenon is very strongly attenuated on curve C6, which corresponds to the speaker provided with a horn whose edge has a convex profile.

Thus, the convex profile enables to improve the directivity of the speaker with a more homogeneous propagated acoustic field.

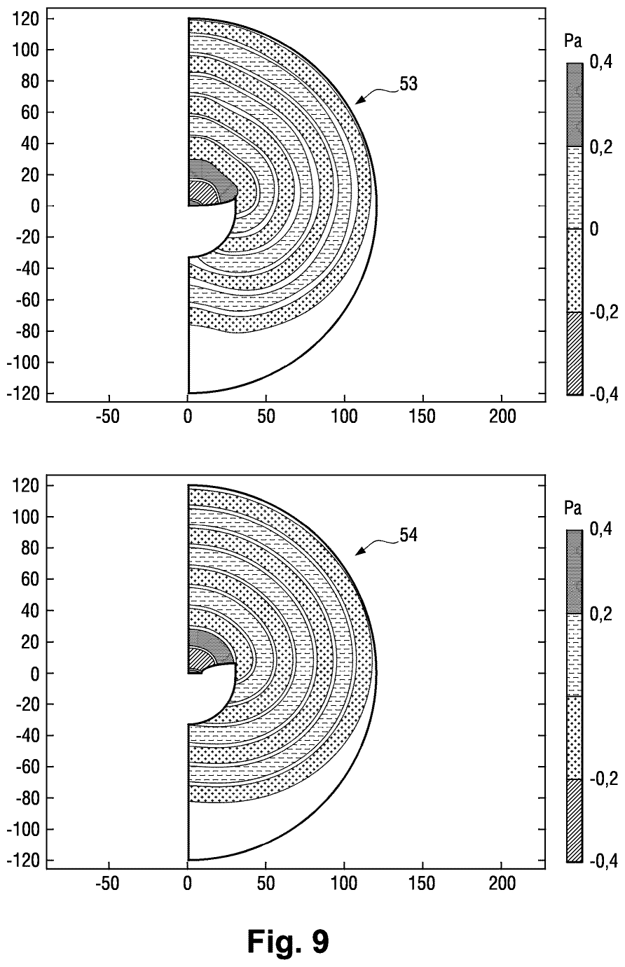

FIG. 9 shows the acoustic field 53 (acoustic power) generated, at the resonance frequency of the horn (equal here to 13.6 kHz), by the speaker provided with a horn whose edge has a concave profile. The acoustic field 54 generated by the speaker provided with a horn whose edge has a convex profile can also be seen. The curves illustrated in FIG. 9 are the result of numerical simulations.

The overpressure/depression lines seen on the left graph (concave horn) are not regular and show a disturbance linked to the shape of the horn. This disturbance is not seen on the graph on the right (convex horn). The convex profile of the edge of the horn therefore, enables a homogenisation of the acoustic field 54 propagated by the horn.

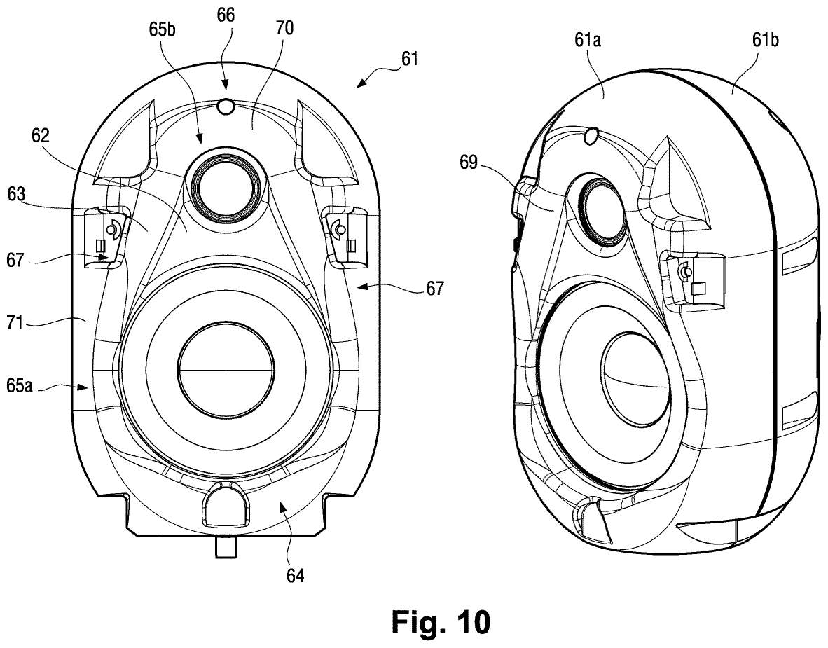

With reference to FIG. 10, a sound box 61 according to a second embodiment, comprises once more, a front half-shell 61a and a rear half-shell 61b.

The acoustic horn 62 is once again integrated into the front half-shell 61a to form a one-piece part.

The contour of the edge 63 has once again, a first curved portion 64, which runs along the lower portion of the first hole 65a, and a second curved portion 66, which runs along the upper portion of the second hole 65b. The contour also comprises two connecting portions 67 which here, are generally rectilinear in shape.

It can be seen here, that the inner side wall 69 of the edge 63 has a convex shape at the second curved portion 66 and the connecting portions 67. The upper surface 70 of the edge 63 is also convex.

Once again, the upper surface 70 of the edge 63 forms a bead on the front face 71 of the box 61. The width of this bead increases progressively towards the top of the box 61 from the bottom of each connecting portion 67, and is maximum at the top of the second curved portion 66.

The profile of the edge 63 is therefore, very rounded, and the horn 61 and the front face form a smooth assembly, with few discontinuities and without angles, which improves the sound rendition.

There is now interest, more precisely, to the support 15 of the speaker 10.

It is known that, on the market, there are different types of speaker supports. Some supports only enable to place the speaker on a horizontal surface (for example, on a table) whereas other supports only enable to attach the speaker on a vertical surface (for example, wall mounting).

Nevertheless, a same support does not enable to position the speaker on a horizontal surface (for example, on a piece of furniture) or on a vertical surface (for example, against a wall).

There is therefore, a need to design a versatile speaker support, i.e. a single support capable of installing/fixing a speaker on different types of external supports (horizontal or vertical). In particular, the speaker support must fulfil the following two functions:
the so-called “table stand” function for positioning the speaker on a horizontal surface;
the so-called “wall mount” function for positioning the speaker on a vertical surface.

The support must also have a shape adapted to the capsule speaker and its curved external surfaces.

The support must ensure aesthetic coherence with the shape of the speaker, in particular, in the case of a capsule-shaped speaker, i.e. one having curved surfaces.

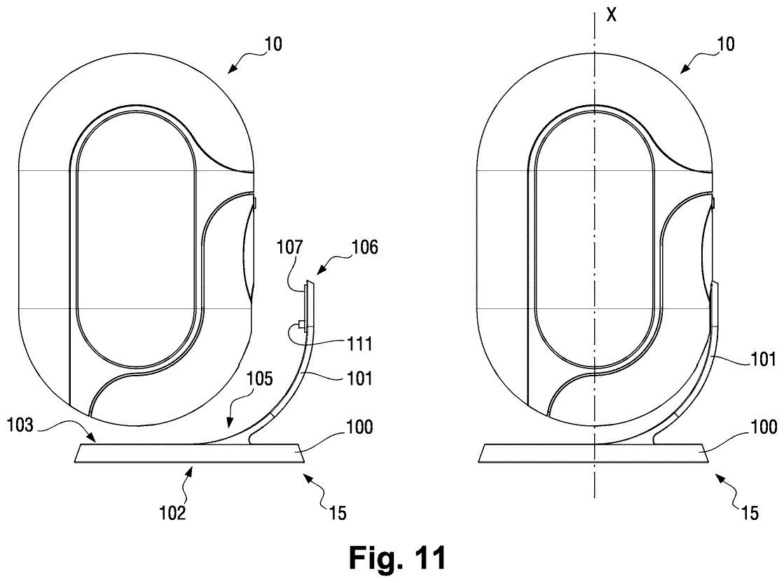

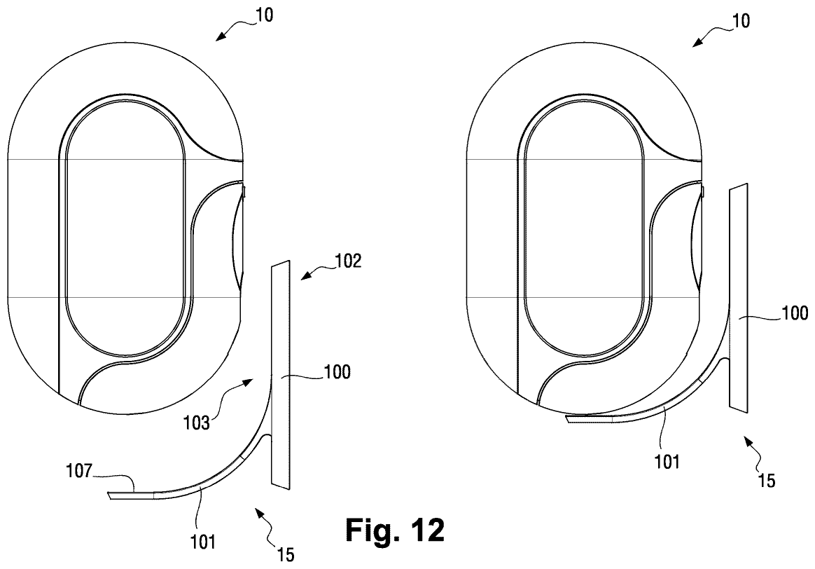

With reference to FIGS. 11 and 12, the support 15 of the speaker 10 comprises:
a base 100;
a curved portion 101.

The base 100 is generally flat-shaped and comprises a first face 102 and a second face 103. The first face 102 is intended to be in contact with an external support (for example, a table, a wall).

The curved portion 101 extends from the second face 103. The curved portion 101 comprises a first end 105 connected to the base 100 and a second free end 106. The curved portion 101 extends radially from the base 100 from its first end 105 to its second end 106.

Preferably, the curved portion 101 comprises a flat surface 107, oriented perpendicularly to the base 100, and comprising fastening means for fixing the flat surface 107 on a surface of the speaker 10. Here, the flat surface 107 of the curved portion 101 is located at the second end 106 of the curved portion 101.

FIG. 11 illustrates the first mounting configuration of the support on the speaker. This configuration is called “table stand”.

In this configuration, the first face 102 of the base 100 of the support 15 is placed on a flat horizontal surface (of a table, for example), and the fixing of the the curved portion 101 to the speaker 10 is done from the rear of the speaker 10. The flat surface 107 is therefore, fixed to the rear face of the speaker 10.

FIG. 12 illustrates the second configuration for mounting the support 15 on the speaker 10. This configuration is called a “wall mount”.

In this configuration, the first face 102 of the base 100 of the support 15 is attached to the wall and the fixing of the curved portion 101 to the speaker 10 is carried out below the speaker 10. The flat surface 107 is therefore, fixed to the lower face of the speaker 10.

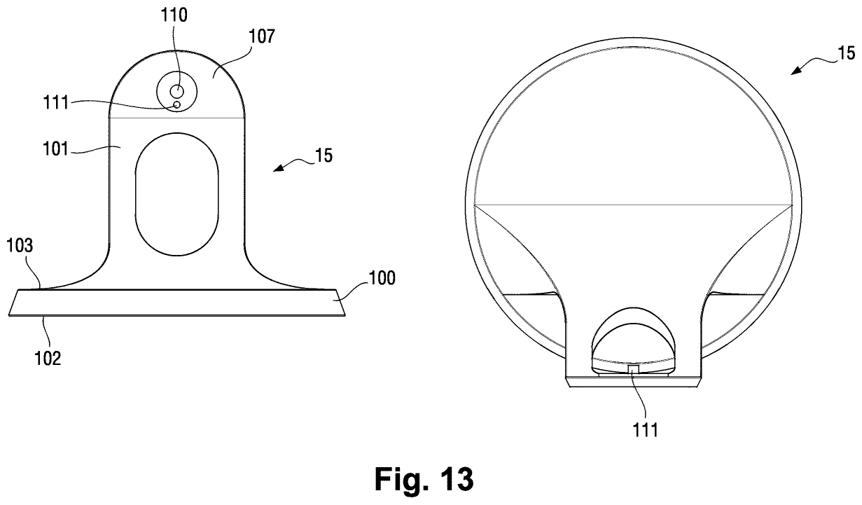

FIG. 13 shows front views of the support 15 in the “table stand” configuration (left drawing) and in the “wall mount” configuration (right drawing).

Preferably, the base 100 and the curved portion 101 of the support 15 are formed as one-piece (i.e. as a single part, for example, aluminium).

For example, the surface of the base 100 is sized so as to ensure the stability of the speaker 10, when it is fixed to the curved portion 101 of the support 15, in particular in the “wall mount” configuration.

The base 100 comprises fastening means for fixing the support on a surface of the external support (for example, by screwing the support 15 on a wall). For example, these fastening means comprise one or more tapped holes formed in the thickness of the base and intended to receive a screw or knurled screw. These fastening means are not shown here.

The base 100 is arranged such that, when the speaker 10 and the support 15 are assembled, the axis of revolution X of the speaker 10 coincides with the centre of the base 100. Also, the surface of the base 100 of the support 15, in contact with the table, is sized such that the projection of the centre of gravity of the speaker 10 is fits within said surface.

Preferably, the curved portion 101 has a bend radius greater than the bend radius of the curved external surface of the capsule speaker 10, such that the curved portion 101 follows the curved shape of the speaker 10 without, however, risking of coming into contact with it.

The flat surface 107 of the second end 106 of the curved portion 101 comprises fastening means for fixing the support to the speaker, either to the rear face of the speaker according to the first mounting configuration, or to the lower portion of the speaker according to the second mounting configuration. The fastening means comprise for example, one or more holes or openings 110, each intended to receive a screw or knurled screw. Here, the fastening means comprise a single tapped hole 110.

Consequently, the capsule speaker 10 comprises one or more tapped holes arranged opposite the hole(s) or openings 110 of the flat surface 107.

The flat surface 107 of the second end 106 of the curved portion 101 further comprise a lug 111, shown in FIG. 11 and FIG. 13. This lug 111 is intended to be inserted into a hole (not shown) formed on one face of the speaker 10, so as to secure the speaker 10 in its vertical position when it is fixed to the support. Thus, there is no risk of the speaker 10 pivoting about the screw passing through the opening 110 formed through the flat surface 107 of the curved portion 101. This is advantageous during the step of fixing the enclosure 10 to its support 15 (i.e. during installation), but also prevents the speaker 10 from pivoting due to the vibrations emitted during the operation of the speaker 10.

Here, the curved portion 101 has a thickness of between 3 mm and 6 mm, preferably 5 mm. Thus, the support 15 is sufficiently robust to maintain the speaker 10 vertically and to prevent it from tilting under the effect of its weight, and without causing oscillations to the speaker 10 on the support when a user manipulates it or due to the vibrations emitted during operation.

It is possible to make the curved portion 101 from plastic. However, there is a risk that the support 15 of the speaker 10 is not rigid enough and vibrates with the speaker 10.

To improve the rigidity of the support and to limit the vibrations of the speaker/support when the speaker 10 is operating, several embodiments are advantageous.

In a first embodiment, the curved portion 101 is made of metal (for example, aluminium) rather than plastic. In a particular embodiment, the entire support is made of metal, for example, the same metal as that used for the base 100 (for example, aluminium), in which case, the support 15 is a one-piece part of metal (which has the advantage of being robust and limiting vibrations compared to plastic).

In a second embodiment, the curved portion 101 is made of plastic but further comprise, a rib on the back of the curved portion. In a particular embodiment, the entire part is made of plastic, preferably in a one-piece, in which case the rib can be easily formed in the curved portion 101.

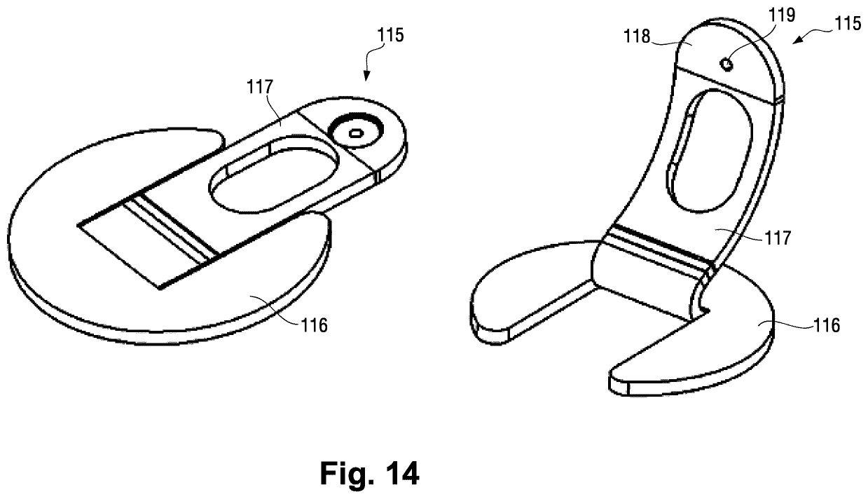

In a third embodiment, shown in FIG. 14, the support 115 can be made from a folding of a metal plate cutout (for example, aluminium). Advantageously, the support 115 is formed of a single part.

The left drawing of FIG. 14 shows the support 115 before the folding, and the right drawing shows the support 115 after the folding. Once again, the support 115 comprises a base 116 and a curved portion 117 having at its free end a flat surface 118, provided with a fixing hole 119, on which the speaker is fixed.

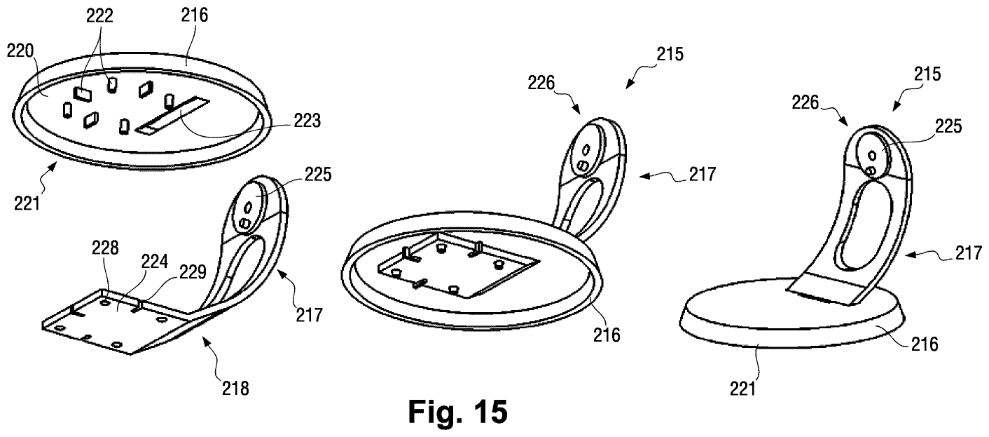

In a fourth embodiment, shown in FIG. 15, the support 215 can be split into two separate parts. By way of example, the support 215 then comprises a plastic stand 216 (the base) and a curved portion 217 made of metal. The first end 218 (tab) of the curved portion 217, made of metal (for example, aluminium), is headed onto the bottom 220 of the first face 221 of the base 216.

The heading is particularly advantageous for attaching the curved portion 217 onto the base 216 for the same reasons as previously indicated (i.e no additional parts, no risk of vibration, reduced bulk, very robust connection). The plastic pins 222 extend vertically from the bottom 220 of the first face 221 of the base 216. The base 216 also comprises a slot 223.

The first end 218 of the curved portion 217 comprises a flat surface 224, that extends orthogonally to the flat surface 225 of the second end 226 of the curved portion. The flat surface 225 has the shape of a circular pellet. The flat surface 224 comprises holes 228, and slots 229 formed in the edges of the flat surface 224. Here, the flat surface 224 is square-shaped; the holes 228 are located in the corners of the flat surface 224 and the slots 229 are located at the midpoints of the three free edges of the flat surface 224.

The flat surface 224 is inserted into the slot 223 and then applied against the bottom 220 of the first face 221 of the base 216, such that the pins 222 are inserted into the holes 228 and the slots 229. The flat surface 224 is then fixed by heading at the bottom 220 of the first face 221 of the base 216.

Naturally, the invention is not limited to the embodiments described, but comprises any variant entering into the scope of the invention such as defined by the claims.

The horn does not necessarily form a one-piece part with a portion of the box. It could be an added part, integrated into the box.

The holes in the horn (and therefore, the diaphragms of the loudspeakers) might not be circular, but have the shape of an ellipse whose major axis has a length different from the minor axis.

It has been described here, that the first loudspeaker (woofer) is integrated at a lower portion of the front face of the box and that the second loudspeaker (tweeter) is integrated at an upper portion of the front face of the box. The position of these loudspeakers could be different. The second loudspeaker could be located under the first loudspeaker. This configuration is advantageous, for example, in the case where the speaker is placed at a height, because it enables to have the second loudspeaker directed towards the listening position. The first loudspeaker and the second loudspeaker are also not necessarily positioned at the lower and upper portions of the speaker, one or both loudspeakers could be positioned at a central portion.

The horn can comprise more than two holes, and therefore, “accommodate” the diaphragms of more than two loudspeakers. In a particular embodiment, the speaker comprises on one side, from top to bottom, a first loudspeaker comprising a diaphragm having a first diameter, a second loudspeaker comprising a diaphragm having a second diameter less than the first diameter, and a third loudspeaker comprising a diaphragm having a third diameter equal to the first diameter. The edge of the horn runs along the lower portion of the first hole in which the diaphragm of the first loudspeaker extends, the sides of the second hole in which the diaphragm of the second loudspeaker extends, and the upper portion of the third hole in which the diaphragm of the third loudspeaker extends.

In this embodiment, the first and third loudspeakers are preferably adapted to render acoustic frequencies of between 100 Hz and 2 kHz. The second loudspeaker is preferably adapted to render acoustic frequencies of between at least 2 kHz and 20 kHz.

In another embodiment, the speaker comprises on one side, from top to bottom, a first loudspeaker comprising a diaphragm having a first diameter, a second loudspeaker comprising a diaphragm having a second diameter less than the first diameter, and a third loudspeaker comprising a diaphragm having a third diameter less than the second diameter. As previously described, the edge of the horn runs along the lower portion of the first hole in which the diaphragm of the first loudspeaker extends, the sides of the second hole in which the diaphragm of the second loudspeaker extends, and the upper portion of the third hole in which the diaphragm of the third loudspeaker extends.

In this other embodiment, the first loudspeaker is preferably adapted to render acoustic frequencies of between 20 Hz and 500 Hz. The second loudspeaker is preferably adapted to render acoustic frequencies of between 500 Hz and 5 kHz. The third loudspeaker is preferably adapted for rendering acoustic frequencies of between 5 kHz and 20 kHz.

More generally, it will be understood that other configurations of the speaker could be considered in the scope of the present invention, as long as the elliptical holes are arranged so as to match the edge of the horn. In practice, the profile of the edge of the horn will be determined depending on the number of loudspeakers and the diameter of their diaphragm to be integrated into the speaker.

In the embodiments described with reference to the Figures, the edge of the horn, the contour of the edge has an avocado shape and more generally a trapezoidal shape having rounded bases and corners and preferably curved sides.

The presence of a flexing point on at least one curved side of the trapezoid, as described with reference to FIG. 3, is such that the contour of the edge of the horn has a narrowing. This is the case, for example, of a speaker comprising a central loudspeaker with a diameter less than the diameters of two other loudspeakers located on either side of the central loudspeaker.

It should also be noted that the trapezoidal shape with rounded bases and corners, is not reserved for a configuration with two loudspeakers. It is possible to have a trapezoidal shape with more than two loudspeakers (and therefore, with at least two first loudspeakers and/or at least two second loudspeakers).

The acoustic speaker in which the box is integrated, is not necessarily in the shape of a capsule.

1. An acoustic horn, arranged to be integrated in a sound box by forming a recess in a face (20; 71) of said sound box, the acoustic horn comprising:
a bottom, in which at least two elliptical holes are formed, in each of which can extend a diaphragm of a loudspeaker integrated into said sound box;
an edge comprising an upper surface defining a contour of the edge and intended to extend over said face of said sound box, and an inner side wall which connects the bottom of the acoustic horn to the upper surface of the edge, the edge partially running along each elliptical hole such that its contour has curved portions matching the shape of said elliptical holes.

2. The acoustic horn according to claim 1, wherein the bottom comprises a first elliptical hole and a second elliptical hole with a diameter less than that of the first elliptical hole, the contour of the edge having the general shape of a trapezoid having rounded bases and angles.

3. The acoustic horn according to claim 2, wherein when the acoustic horn is viewed in cross-section along a plane perpendicular to a flat surface of the bottom, the inner side wall of the edge has a convex shape, at least on a curved portion of the edge which runs along the second elliptical hole.

4. The acoustic horn according to claim 2, wherein a maximum distance between each elliptical hole and the inner side wall of the edge is less than or equal to half a wavelength corresponding to a maximum frequency rendered by the loudspeaker having a diaphragm that can extend into the second elliptical hole.

5. The acoustic horn according to claim 2, wherein a maximum depth of the acoustic horn is less than or equal to half a wavelength corresponding to a maximum frequency rendered by the loudspeaker having a diaphragm that can extend into the second elliptical hole.

6. A One-piece part, forming a portion of a sound box, the one-piece part comprising a face of said sound box and integrating an acoustic horn according to claim 1, the acoustic horn forming a recess in said face.

7. A sound box comprising an acoustic horn according to claim 1.

8. An acoustic speaker comprising a sound box according to claim 7 and at least two loudspeakers integrated in the sound box, a diaphragm of each loudspeaker extending into one of the elliptical holes of the acoustic horn.

9. The acoustic speaker according to claim 8, the bottom of the acoustic horn comprising a first elliptical hole and a second elliptical hole with a diameter less than that of the first elliptical hole, the speaker comprising a first loudspeaker having a diaphragm that extends into the first elliptical hole and a second loudspeaker having a diaphragm that extends into the second elliptical hole.

10. The acoustic speaker according to claim 9, a maximum distance between each elliptical hole and the inner side wall of the edge of the acoustic horn being less than or equal to half a wavelength corresponding to a maximum frequency rendered by the second loudspeaker.

11. The acoustic speaker according to claim 9, a maximum depth of the acoustic horn being less than or equal to half a wavelength corresponding to a maximum frequency rendered by the second loudspeaker.

12. The acoustic speaker according to claim 9, the first loudspeaker being recessed deeper into the box than the second loudspeaker.

13. A sound box comprising a one-piece part according to claim 6.
